(19) United States
(12) Patent Application Publication
(10) Pub. No.: US 2012/0005579 A1
(43) Pub. Date: Jan. 5, 2012

(54) INFORMATION PROCESSING APPARATUS, CONTROL METHOD THEREOF, AND PROGRAM

(75) Inventor: Tetsuya Yamada, Kawasaki-shi (JP)

(73) Assignee: CANON KABUSHIKI KAISHA, Tokyo (JP)

(21) Appl. No.: 13/159,765

(22) Filed: Jun. 14, 2011

(30) Foreign Application Priority Data
Jun. 30, 2010 (JP) 2010-150259

(51) Int. Cl. G06F 3/01; G06F 15/16

(52) U.S. Cl. 715/733

(57) ABSTRACT

An information processing apparatus is provided. The apparatus includes a Web browser which can hold a plurality of items of screen data provided by a Web server, and can selectively display one of a plurality of screens each of which corresponds to one of the plurality of items of screen data on a foreground of the Web browser. In the apparatus, a control unit controls, based on a definition included in the screen data, a state of a device provided with the apparatus. A recognition unit recognizes a screen which is being displayed on the foreground of the Web browser. The control unit controls the state of the device based on the definition included in the screen data which corresponds to the screen recognized by the recognition unit.

### BACKGROUND OF THE INVENTION

1. Field of the Invention

The present invention relates to an information processing apparatus, control method thereof, and program.

2. Description of the Related Art

It is known that an information processing apparatus such as a PC (Personal Computer) is connected to a Web server on a network, and an operation screen provided by the Web server is displayed on the Web browser of the information processing apparatus. In this case, the Web browser of the information processing apparatus first requests an operation screen of the Web server. Upon receiving the request from the information processing apparatus, a Web application in the Web server sends back, as a response to the information processing apparatus, HTML data for displaying the operation screen on the Web browser. The Web browser of the information processing apparatus parses the received HTML data, and displays an operation screen based on the description of the HTML data. If the user inputs an instruction via the operation screen displayed on the Web browser, the Web browser notifies the Web server of the input instruction. Upon receiving the notification, the Web application in the Web server executes processing according to the input instruction.

Some recent MFPs (Multi Function Peripherals) having a scanner and printer include the above-mentioned Web browser. The MFP displays an operation screen provided by the Web server using the above procedures on the Web browser of the MFP, and accepts various instructions from the user.

According to a technique disclosed in Japanese Patent Laid-Open No. 2008-003833, the Web server provides an operation screen for inputting an instruction to use each function of an MFP, and a control script for controlling the MFP in accordance with the operation. More specifically, the user of the MFP inputs an instruction to the MFP via an operation screen displayed on the Web browser. The control script is executed according to the input instruction. The control script requests the MFP to execute various processes in accordance with the contents of the instruction input by the user. The requested MFP executes the requested processes. This obviates the necessity to hold all menu data in the MFP to operate it. Also, the user can easily change menu data on the Web server.

A technique disclosed in Japanese Patent Laid-Open No. 2008-131388 proposes a Web browser plug-in for asynchronously communicating with the controller of an MFP to control the screen in synchronization with various events (for example, generation of abnormality) in the MFP that occur asynchronously from a user operation.

There is a tab browser in which one Web browser holds a plurality of Web pages and allows switching between display and non-display using tabs.

In Japanese Patent Laid-Open No. 2008-003833, the MFP is controlled based on an HTML data script. To the contrary, in Japanese Patent Laid-Open No. 2008-131388, the screen is controlled based on an event which occurs regardless of an operation to the operation screen by the user. In another case, the screen may be controlled at the timing of completion of loading HTML data.

However, when the Web browser of the MFP is implemented by the tab browser, execution of a script at the timing of completion of loading HTML data does not always match the time when HTML data containing the script to be executed is actually displayed. Thus, a mismatch may occur in control of MFP resources that needs to be synchronized with the display state, like a tally lamp indicating whether a start button used to start execution of scanning can be pressed. For example, while displaying the tab of an application which does not use a scan operation, the tally lamp may shift to a state indicating that the start button can be pressed.

### SUMMARY OF THE INVENTION

The present invention has been made to overcome the conventional drawbacks, and provides a technique capable of controlling a device in accordance with the type of operation screen actually displayed on a Web browser.

According to one aspect of the present invention, an information processing apparatus is provided. The apparatus includes a Web browser which can hold a plurality of items of screen data provided by a Web server, and can selectively display one of a plurality of screens each of which corresponds to one of the plurality of items of screen data on a foreground of the Web browser. In the apparatus, a control unit controls, based on a definition included in the screen data, a state of a device provided with the apparatus. A recognition unit recognizes a screen which is being displayed on the foreground of the Web browser. The control unit controls the state of the device based on the definition included in the screen data which corresponds to the screen recognized by the recognition unit.

Further features of the present invention will become apparent from the following description of exemplary embodiments (with reference to the attached drawings).

### BRIEF DESCRIPTION OF THE DRAWINGS

FIG. 1 is a view showing the overall configuration of an information processing system according to an embodiment of the present invention;

FIGS. 2A and 2B are a block diagram and view, respectively, showing the arrangements of an MFP 101 and operation unit 219;

FIG. 3 is a block diagram showing the configuration of a Web server 102;

FIG. 4 is a block diagram showing the software configuration of the information processing system;

FIG. 5 is a chart showing the overall processing sequence of the information processing system;

FIG. 6 is a view exemplifying screen transition of a Web browser 440;

FIG. 7 is a view exemplifying HTML data and a control script for screen display;

FIG. 8 is a table exemplifying a management table managed by a tab manager 453;

FIGS. 9A and 9B are flowcharts each showing the processing sequence of an operation unit controller 450;

FIG. 10 is a block diagram showing the software configuration of an information processing system according to an alternative embodiment of the present invention; and

FIG. 11 is a chart showing the overall processing sequence of the information processing system.

### DESCRIPTION OF THE EMBODIMENTS

Embodiments of the present invention will be described in detail below with reference to the accompanying drawings. It should be understood that the following embodiments are not intended to limit the scope of the appended claims, and that not all combinations of features set forth in the embodiments are indispensable for the means of solution in the present invention.

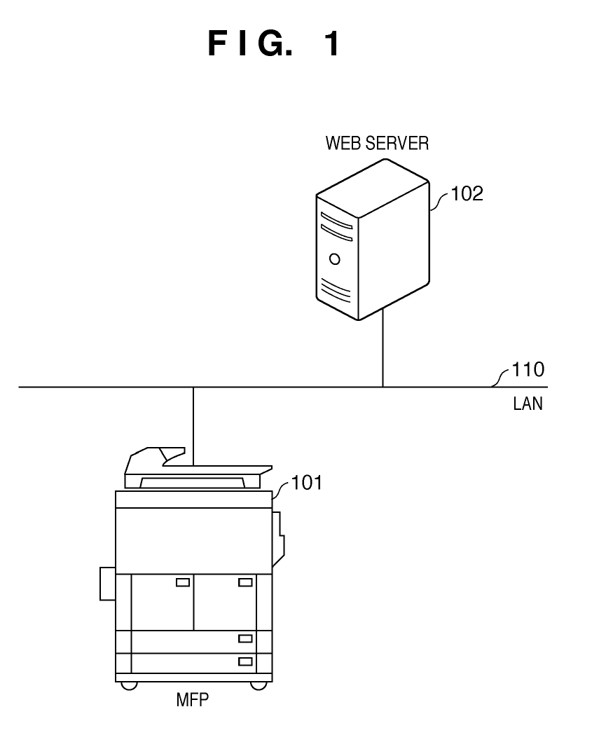

According to the embodiment, the screen state and the state of MFP resources can match each other when a control script processed by an MFP browser is executed.

<Hardware Configuration of Information Processing System (FIGS. 1 to 3)>

[Overall Configuration (FIG. 1)]

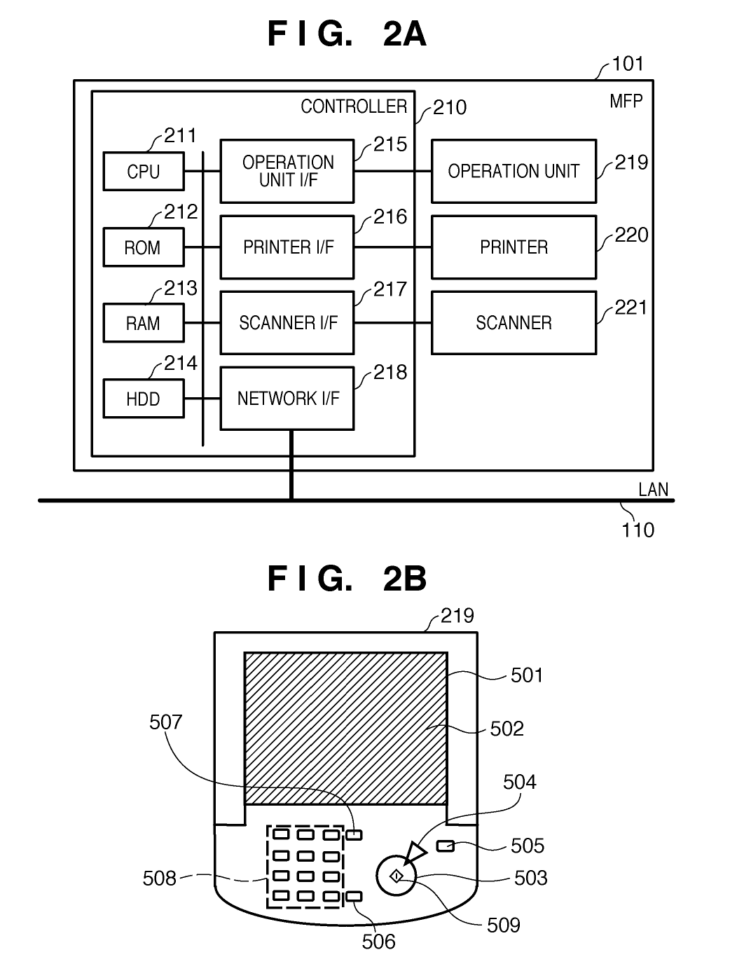

An information processing system according to the embodiment includes an MFP 101 and Web server 102. The MFP 101 and Web server 102 are connected to a network such as a LAN 110 and can communicate with each other.

[Hardware Configuration of MFP (FIG. 2A)]

A controller 210 including a CPU 211 controls the whole operation of the MFP 101. The CPU 211 performs various control operations such as reading control and transmission control by reading out control programs stored in a ROM 212. A RAM 213 is used as a temporary storage area such as a main memory or work area for the CPU 211. An HDD 214 stores image data, various programs, or various information tables (to be described later). An operation unit I/F 215 connects an operation unit 219 and the controller 210. The MFP 101 has a Web browser function (to be described later). The Web browser of the MFP 101 parses HTML data received from the Web server 102, and displays an operation screen based on the description of the received HTML data on the liquid crystal display unit of the operation unit 219. A printer I/F 216 connects a printer 220 and the controller 210. Image data to be printed by the printer 220 is transferred from the controller 210 via the printer I/F 216, and printed on a printing medium by the printer 220. A scanner I/F 217 connects a scanner 221 and the controller 210. The scanner 221 reads an image on a document to generate image data, and outputs the generated image data to the controller 210 via the scanner I/F 217. A network I/F 218 connects the controller 210 (MFP 101) to the LAN 110. The network I/F 218 transmits image data and information to an external apparatus (for example, the Web server 102) on the LAN 110, or receives various kinds of information from the external apparatus on the LAN 110.

(Detailed Arrangement of Operation Unit (FIG. 2B))

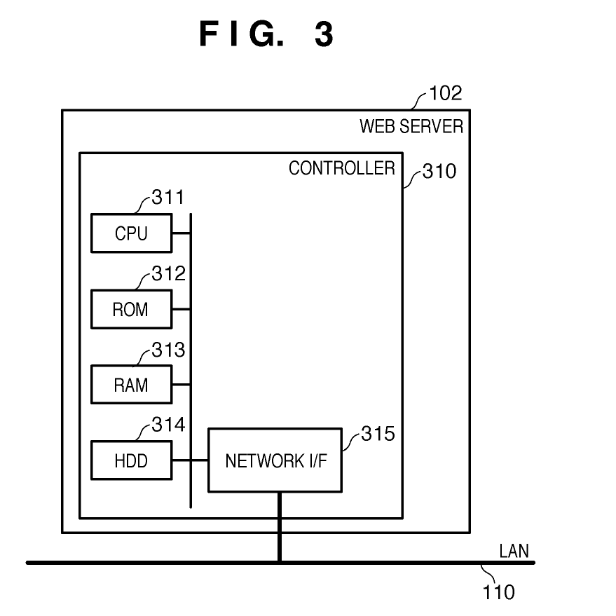

The operation unit 219 includes various hard keys such as a start key 503, stop key 504, reset key 505, guide key 506, top menu key 507, and numeric key pad 508. As an auditory user interface function, the operation unit 219 has a function of providing an operation guide by a buzzer or voice. The start key 503 is used to designate the start of a document image reading operation. A two-color LED display unit 509 (lighting lamp) having light emitting diodes of two, green and red is arranged at the center of the start key 503. The two-color LED display unit 509 indicates by its color whether the start key 503 is available. That is, the two-color LED display unit 509 functions as a device which presents, to the user, information about whether a predetermined operation is permitted. The two-color LED display unit 509 is disposed at a position close to the start key 503 (in the embodiment, a position overlapping the start key 503). The stop key 504 is used to stop a running operation. The reset key 505 is used to initialize settings. The guide key 506 is used to display the usage of the MFP 101. The top menu key 507 is used to display a top menu screen for selecting a function of the MFP 101. The numeric key pad 508 is used to input numeric values.

[Hardware Configuration of Web Server (FIG. 3)]

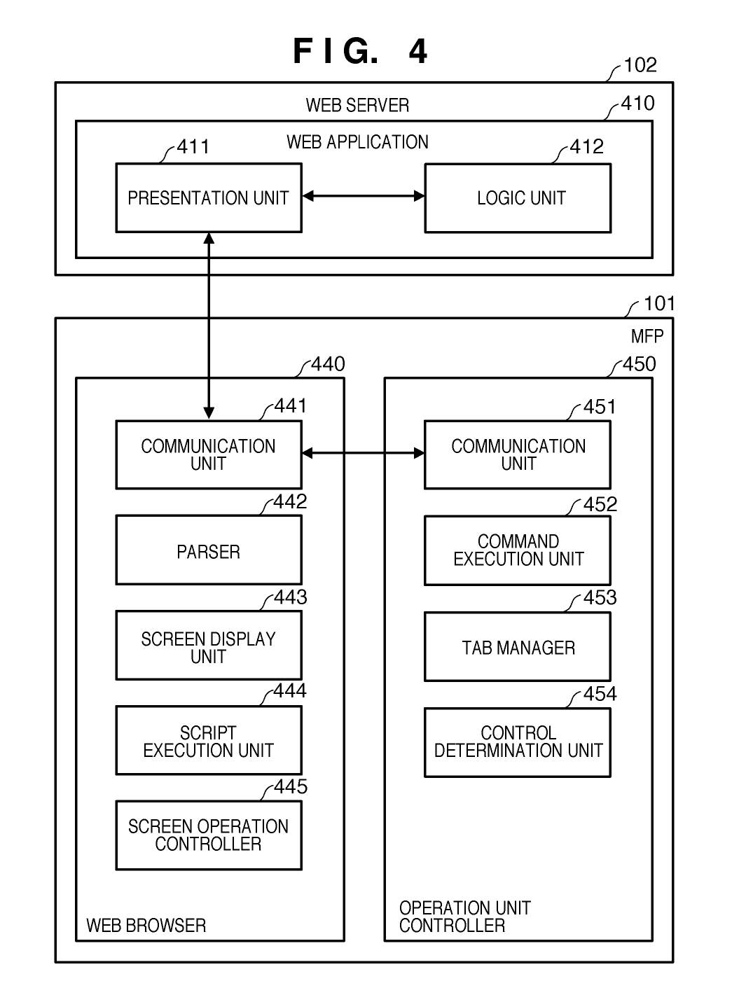

A controller 310 including a CPU 311 controls the whole operation of the Web server 102. The CPU 311 executes various control processes by reading out control programs stored in a ROM 312. A RAM 313 is used as a temporary storage area such as a main memory or work area for the CPU 311. An HDD 314 stores image data, various programs, or various information tables (to be described later). A network I/F 315 connects the controller 310 (Web server 102) to the LAN 110. The network I/F 315 transmits/receives various kinds of information to/from another apparatus connected to the LAN 110.

<Software Configuration of Information Processing System (FIG. 4)>

[Software Configuration of MFP]

The MFP 101 includes a Web browser 440 and operation unit controller 450. The Web browser 440 and operation unit controller 450 are implemented by executing control programs by the CPU 211 of the MFP 101. The Web browser 440 can hold a plurality of operation screens of different types provided from the Web browser. The Web browser 440 can switch between these operation screens to display one of them in accordance with a user instruction. The Web browser 440 includes a communication unit 441, parser 442, screen display unit 443, script execution unit 444, and screen operation controller 445.

The communication unit 441 communicates with a presentation unit 411 of a Web application 410 according to the HTTP protocol. More specifically, the communication unit 441 requests, of the Web application 410, an operation screen to be displayed on the Web browser 440. The communication unit 441 receives a response (processing result) transmitted from the Web application 410. Further, the communication unit 441 transmits a function execution request to a communication unit 451 of the operation unit controller 450.

The parser 442 parses the response received from the Web application 410. The response contains HTML data and a control script. The HTML data contains a description indicating the contents of an operation screen to be displayed on the Web browser 440. The control script contains a description for controlling a function of the MFP 101. The screen display unit 443 displays an operation screen on the operation unit 219 based on the HTML data parse result.

The script execution unit 444 performs processing based on the control script parse result. The control script contains a code which issues an instruction to the operation unit controller 450 to control a function of the MFP 101, and a code which performs processing such as screen update in accordance with a response from the operation unit controller 450. The screen operation controller 445 controls the user interface of the Web browser 440. Examples of the user interface control are validation/invalidation of the input button and display/non-display.

The operation unit controller 450 recognizes the type of operation screen actually displayed on the Web browser 440, and shifts the two-color LED display unit to a state after shift which corresponds to the recognized type of operation screen and is stored in a tab manager 453. More specifically, the operation unit controller 450 includes the communication unit 451, a command execution unit 452, the tab manager 453, and a control determination unit 454. The communication unit 451 accepts a processing request and notification from the communication unit 441 of the Web browser 440. The command execution unit 452 generates and executes a control command for the MFP 101 in correspondence with the processing request. For each tab of the Web browser 440, the tab manager 453 manages a state in which the operation unit such as the two-color LED display unit 509 should be set in correspondence with a screen displayed by the tab. The control determination unit 454 determines MFP resource control based on, for example, information and the tab display state, which are managed by the tab manager 453. The control determination unit 454 instructs the command execution unit 452 to execute a control command. Note that the tab manager 453 and control determination unit 454 may reside in the Web browser 440 or operation unit controller 450.

[Software Configuration of Web Server]

The Web server 102 includes the Web application 410. The Web application 410 is implemented by executing a control program by the CPU 311 of the Web server 102.

The Web application 410 receives information transmitted as a request from the Web browser 440, and executes processing based on the received information. The processing result is transmitted as a response from the Web application 410 to the Web browser 440.

The Web application 410 includes the presentation unit 411 and a logic unit 412. The presentation unit 411 communicates with the communication unit 441, and receives a request transmitted from the MFP 101. The presentation unit 411 notifies the logic unit 412 of the received request, and waits for a response from the logic unit 412. Upon receiving the response from the logic unit 412, the presentation unit 411 transmits, as a response, HTML data and a control script corresponding to an operation screen to be displayed on the Web browser 440 of the MFP 101 in accordance with the response contents.

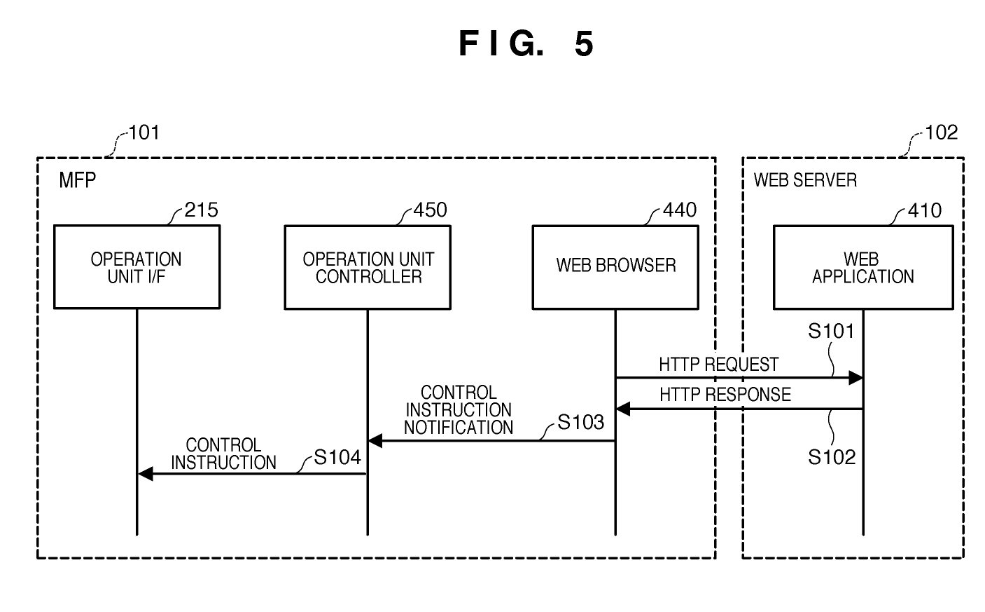

The logic unit 412 executes various processes in accordance with a request notified from the presentation unit 411. In addition, the logic unit 412 generates HTML data of screen information to be displayed on the MFP 101 and the control script of processing to be executed by the MFP 101. An example of the control script is one for requesting execution of print processing by the printer 220 of the MFP 101, execution of reading processing by the scanner 221, or execution of transmission processing via the network I/F 218. When the MFP 101 is requested to execute processing, the logic unit 412 transfers, to the presentation unit 411, the HTML data and control script to be sent back as a response to the MFP 101.

<Processing Sequence of Information Processing System>

[Overall Processing Sequence (FIG. 5)]

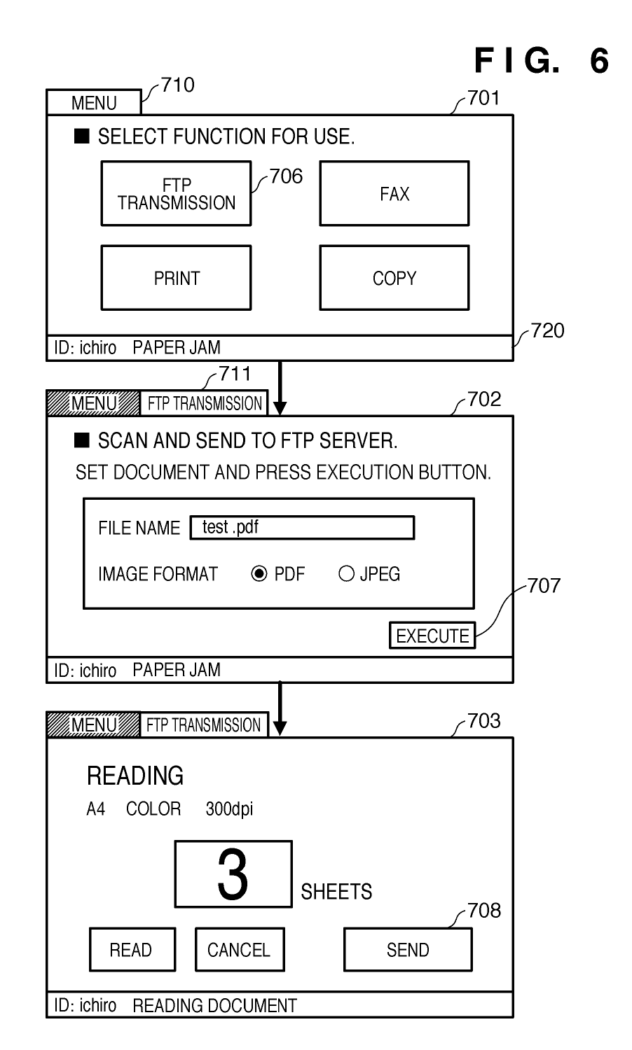

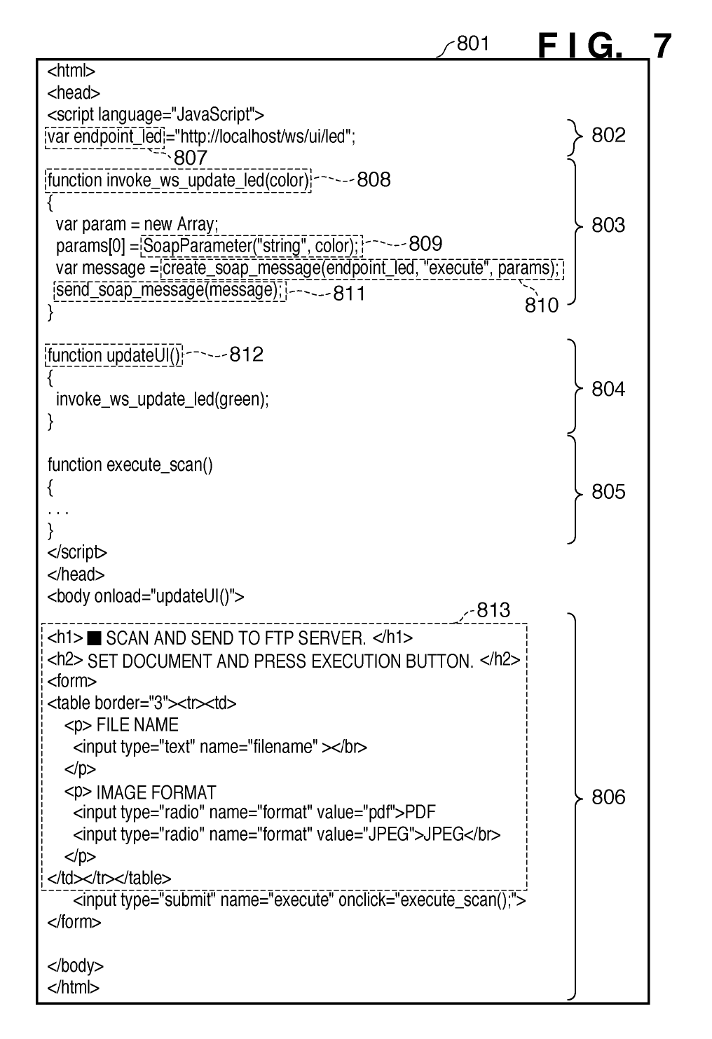

When the user activates the Web browser 440 of the MFP 101, the Web browser 440 sends an HTTP request to the Web application 410 (step S101). Upon receiving the request, the Web application 410 generates HTML data of a screen to be displayed on the Web browser 440 and a control script to be executed by the Web browser 440, and sends them back as a response to the Web browser 440 (step S102). For example, when the HTTP request is a scan execution screen request, scan screen display HTML data and a scan execution control script are sent back as a response. Details of this processing will be described later with reference to FIGS. 6 and 7. The Web browser 440 parses the received HTML data, and displays a screen. Also, the Web browser 440 parses the received control script, and notifies the operation unit controller 450 to execute control of operation unit resources (step S103). The exemplified scan execution control script includes a description for executing a scan job, and job execution processing is done separately. However, this is irrelevant to the present invention, and a description thereof will be omitted. Upon receiving the notification in step S103, the operation unit controller 450 controls the control determination unit 454 to make a determination, and if necessary, instructs the operation unit I/F 215 to execute control (step S104).

(Example of Screen Transition of Web Browser (FIG. 6))

First, a tab 710 displays a menu screen 701. When the user selects a function, a new tab 711 displays the screen of the selected function. At this time, the operation unit controller 450 is notified that the displayed tab has changed. On the newly displayed tab 711, processing proceeds on an FTP transmission setting screen 702 and scan screen 703. The respective screens are displayed on the Web browser 440 and change in accordance with the user operation and control scrip.

The menu screen 701 is used to select a function to be used in the MFP 101. On this screen, the user cannot press the start key 503 (operation button for accepting an input operation from the user), so the two-color LED display unit 509 needs to be in red to indicate that it is unavailable. When the user selects a function from this screen, the screen changes to one corresponding to the selected function. The FTP transmission setting screen 702 appears when the user presses an FTP transmission button 706 on the menu screen 701 to use the FTP transmission function. The user makes settings for FTP transmission on this screen, and designates execution of the FTP transmission function. The start key 503 can be pressed on this screen, so the two-color LED display unit 509 changes to green to indicate that it is available. The scan screen 703 appears when the user presses an execution button 707 on the FTP transmission setting screen 702 to start the FTP transmission function. On this screen, the control script controls the scan job and performs control such as continuous sheet reading.

Reference numeral 720 denotes a status display line. In the example of the menu screen 701, user “ichiro” with “ID: ichiro” has logged in, and the print engine status of the MFP is “paper jam”. These two displays represent the MFP state, and the controller 210 acquires the state and issues a display control instruction. On the scan screen 703, the Web application issues a displays instruction, and “reading document” is displayed.

(Example of HTML Data and Control Script (FIG. 7))

An HTML data & control script 801 shown in FIG. 7 is dynamically generated in accordance with a request from the MFP 101, and used to display the FTP transmission setting screen 702. A block 802 sets some parameters for controlling the operation unit 219. In an endpoint_led variable 807, URL information is set as an end point for sending a request to the operation unit controller 450 to control the two-color LED display unit 509.

A block 803 describes processing of actually invoking the operation unit controller 450 to control the two-color LED display unit 509. In this example, the operation unit controller 450 is invoked using SOAP, and an invoke_ws_update_led function 808 is defined. A SoapParameter function 809 is used to generate a SOAP parameter, and the two LED colors are set as “String” data in this example. A create_soap_message function 810 generates a SOAP message to instruct the end point on execution. Further, a send_soap_message function 811 actually executes a SOAP request for the operation unit controller 450.

A block 804 defines an update_ui function 812, and performs processing of designating green as an argument and invoking the invoke_ws_update_led function 808. A block 805 defines an execute_scan function, and performs processing for a scan job when the user makes settings on a displayed screen and presses the execution button. A block 806 defines a screen to be displayed on the Web browser 440. In addition to contents to be displayed on the screen, the block 806 defines a user input form 813. The form 813 allows inputting the name of a file to be FTP-transmitted and selecting the file format. When the user presses the execution button, the execute_scan function in the block 805 is invoked.

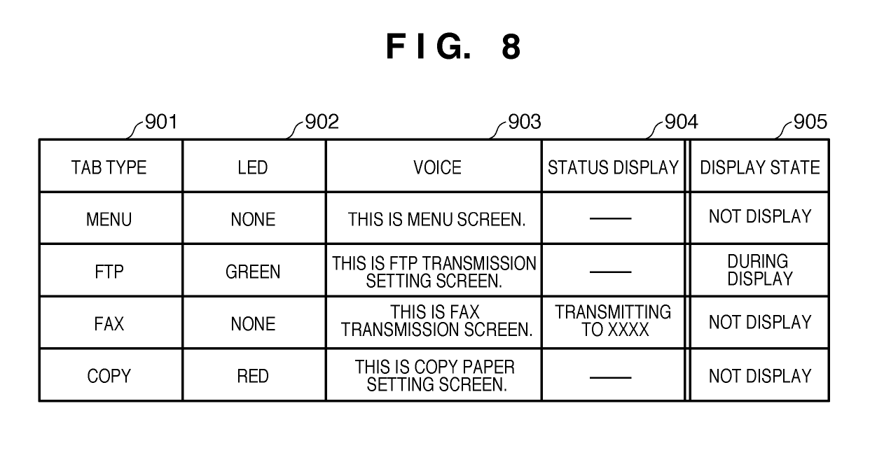

(Example of Information Managed by Tab Manager 453 (FIG. 8))

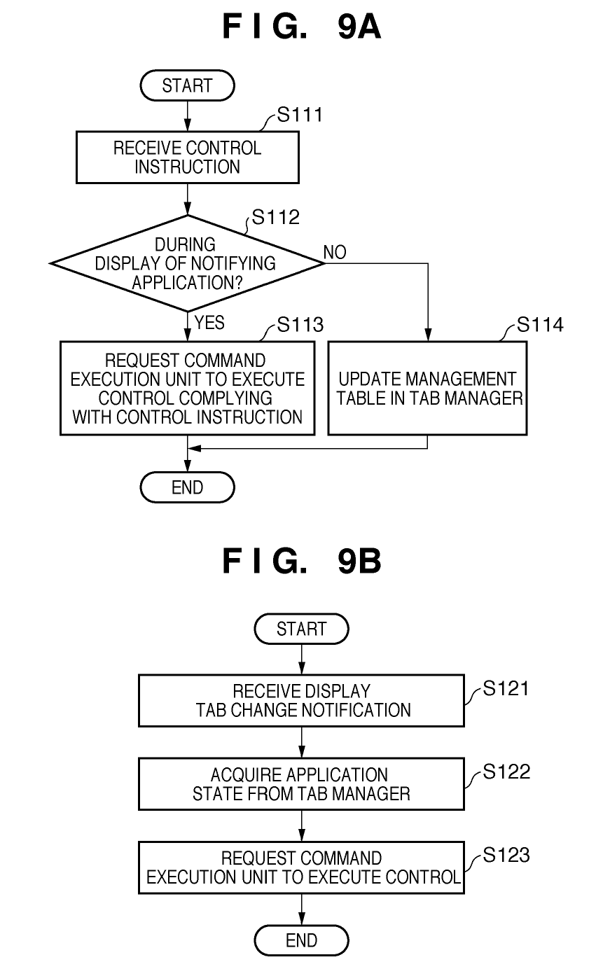

A tab type 901 represents the name of a Web application indicating a tab type. An LED 902 manages a state after shift to which the two-color LED display unit 509 should shift in accordance with the tab type 901 displayed by the Web browser. A voice 903 manages a message to be read by a voice reading function of reading a screen state by voice. For example, the voice reading function reads a screen name every time the screen changes. A status display 904 manages a text displayed by each Web application on the status display line. A display state 905 manages whether the Web browser 440 displays a tab indicated by the tab type 901. The tab manager 453 stores the pieces of information 901 to 904 in FIG. 8, and updates only the display state 905, as needed.

[Processing Sequence of Operation Unit Controller (FIGS. 9A and 9B)]

(Case in Which Control Instruction Is Received (FIG. 9A))

If the operation unit controller 450 receives a control instruction notification from the Web browser 440 (step S111 (corresponding to step S103 in FIG. 5)), the control determination unit 454 determines whether a tab indicating an application which has issued the control instruction is being displayed (step S112). If the tab is being displayed, the control determination unit 454 requests the command execution unit 452 to execute control complying with the control instruction (step S113). If the tab is not being displayed, the control determination unit 454 requests the tab manager 453 to update the management table (step S114).

(Case in Which Display Tab Change Notification Is Received (FIG. 9B))

If the operation unit controller 450 receives, from the Web browser 440, a notification that the tab during display has changed (step S121), it acquires, from the tab manager 453, a resource control state of the MFP 101 that corresponds to the state of the displayed application (step S122), and requests the command execution unit 452 to execute control (step S123).

As described above, the embodiment can control LED lighting in accordance with the type of operation screen (tab) actually displayed on the foreground of the Web browser.

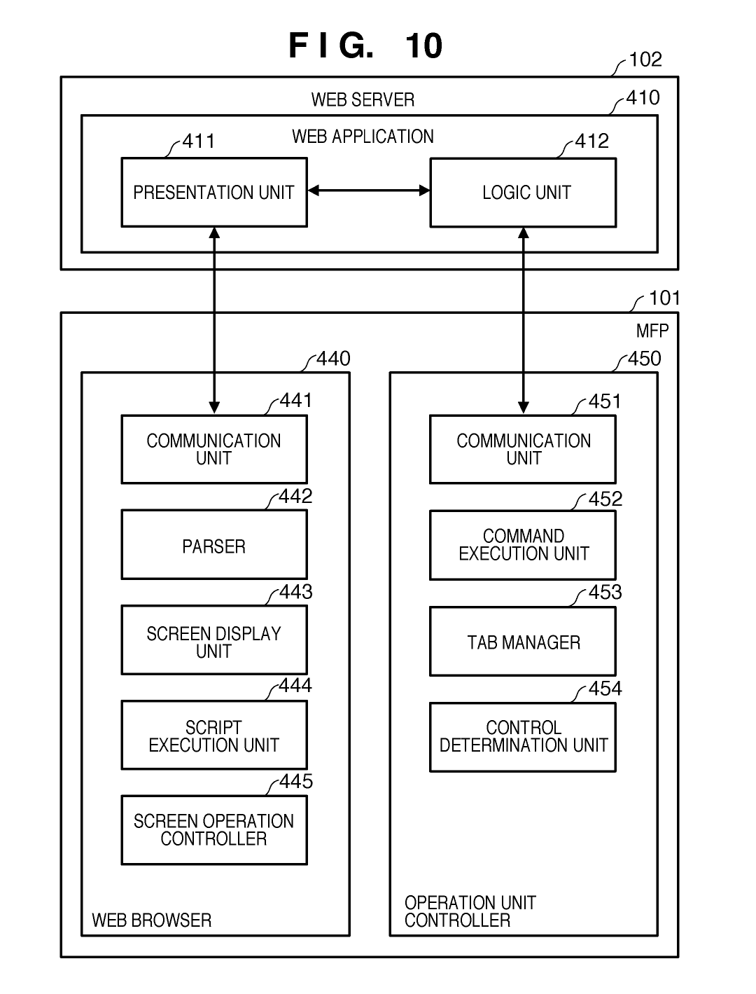

In an alternative embodiment, MFP resources are controlled not from the Web browser but from a Web application in the Web server.

<Software Configuration of Information Processing System (FIG. 10)>

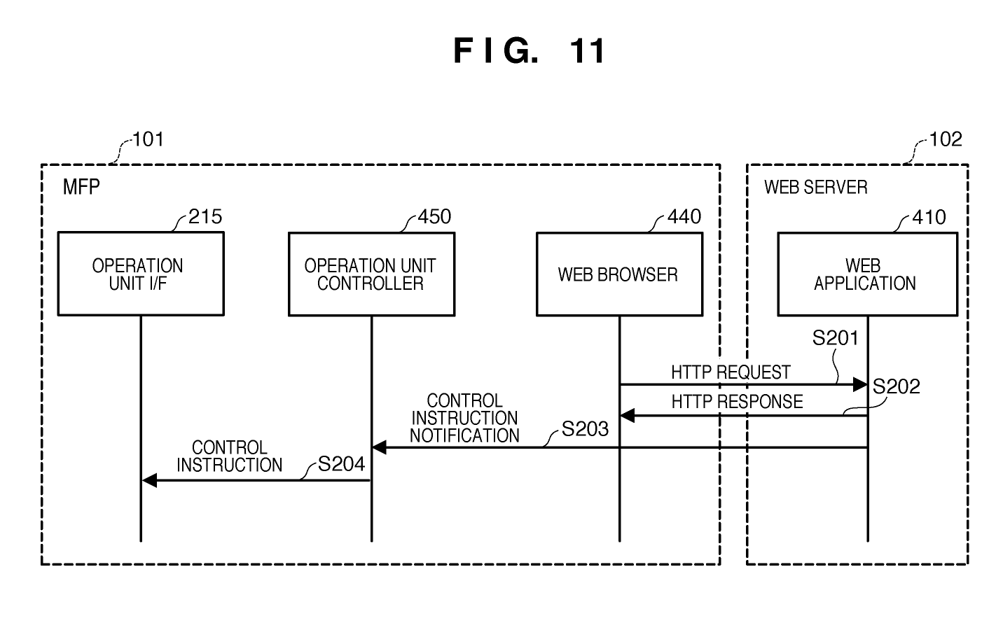

A Web application 410 requests an MFP 101 to execute processing in accordance with the contents of an instruction from the Web browser. At this time, a logic unit 412 requests control via a communication unit 451 of an operation unit controller 450. HTML data to be sent back to a Web browser 440 does not contain a script for controlling the MFP 101, and the Web browser 440 does not request control of a screen operation controller 445. However, it is notified that the displayed tab has changed. When the communication unit 451 receives a control notification though the transmission source is different, the screen operation controller 445 executes the same operation as that in the above-described embodiment.

<Overall Processing Sequence of Information Processing System (FIG. 11)>

When the user activates the Web browser 440 of the MFP 101, the Web browser 440 sends an HTTP request to the Web application 410 (step S201). Upon receiving the request, the Web application 410 generates HTML data of a screen to be displayed on the Web browser 440 and a control script to be executed by the Web browser 440, and sends them back as a response to the Web browser 440 (step S202). For example, when the HTTP request is a scan execution screen request, scan screen display HTML data and a scan execution control script are sent back as a response. The logic unit 412 of the Web application 410 generates a control script, and transmits the generated control script to the operation unit controller 450 (step S203). Upon receiving the notification in step S203, the operation unit controller 450 controls a control determination unit 454 to make a determination, and if necessary, instructs an operation unit I/F 215 to execute control (step S204).

Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-150259, filed Jun. 30, 2010, which is hereby incorporated by reference herein in its entirety.

What is claimed is:

1. An information processing apparatus having a Web browser which can hold a plurality of items of screen data provided by a Web server, and can selectively display one of a plurality of screens each of which corresponds to one of the plurality of items of screen data on a foreground of the Web browser, the apparatus comprising;
a control unit configured to control, based on a definition included in the screen data, a state of a device provided with the information processing apparatus; and
a recognition unit configured to recognize a screen which is being displayed on the foreground of the Web browser;
wherein the control unit controls the state of the device based on the definition included in the screen data which corresponds to the screen recognized by the recognition unit.

2. The information processing apparatus according to claim 1, wherein the device includes a lighting lamp.

3. The information processing apparatus according to claim 1, wherein the device notifies a user of whether or not a start key is available.

4. The information processing apparatus according to claim 3, further comprising a scanner unit configured to read an image on an original,
wherein a user can cause the scanner unit to read the image on the original by operating the start key.

5. The information processing apparatus according to claim 1, wherein when the screen which is being displayed on the foreground of the Web browser is switched to a new screen, the control unit controls the state of the device based on the definition included in the screen data which corresponds to the newly displayed screen.

6. A method of controlling an information processing apparatus having a Web browser which can hold a plurality of items of screen data provided by a Web server, and can selectively display one of a plurality of screens each of which corresponds to one of the plurality of items of screen data on a foreground of the Web browser, the method comprising;
a control step of controlling, based on a definition included in the screen data, a state of a device provided with the information processing apparatus; and
a recognition step of recognizing a screen which is being displayed on the foreground of the Web browser;
wherein the state of the device is controlled in the control step based on the definition included in the screen data which corresponds to the screen recognized in the recognition step.

7. A program for controlling an information processing apparatus having a Web browser which can hold a plurality of items of screen data provided by a Web server, and can selectively display one of a plurality of screens each of which corresponds to one of the plurality of items of screen data on a foreground of the Web browser, the program causing a computer to function as;
a control unit configured to control, based on a definition included in the screen data, a state of a device provided with the information processing apparatus; and
a recognition unit configured to recognize a screen which is being displayed on the foreground of the Web browser;
wherein the control unit controls the state of the device based on the definition included in the screen data which corresponds to the screen recognized by the recognition unit.
